(19) United States
(12) Patent Application Publication
(10) Pub. No.: US 2007/0127441 A1
(43) Pub. Date: Jun. 7, 2007

(54) IP phone server for a KSUless telephone system

(76) Inventors: Yang-Hsin Lin, Hsinchu (TW); Chun-Hung Chen, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/295,573

(22) Filed: Dec. 7, 2005

(51) Int. Cl. H04L 12/66; H04L 12/56

(52) U.S. Cl. 370/352; 370/401

(57) ABSTRACT

The present invention discloses a IP phone server for a KSUless telephone system, wherein a data intercom device is used to transmit the data, which comes from a primary phone line, to a time division multiplex system, and the time division multiplex system transforms the data received from the data intercom device into time division multiplex data in order to enable at least one communication device to make a IP phone call via the primary phone line; then, the input data is encoded/decoded by a processor and then transmitted to at least one IP phone module and then sent out via a network system. The present invention can implement general basic phone sets without IP phone function to have the function of making/receiving IP phone calls; thereby, general basic phone sets can acquire IP phone function without extra expense.

### BACKGROUND OF THE INVENTION

1. Field of the Invention

The present invention relates to a IP phone server, particularly to a IP phone server for a KSUless telephone system (KSU: Key Service Unit)

2. Description of the Related Art

With the advance of science and technology, networks have spread globally, and almost all science & technology products can be operated via wired or wireless networks now; thereby, the performance and convenience of science & technology products is further promoted. Traditionally, phone systems interconnect with phone lines, but now, the “IP phone” appears, and just as hinted by its nomenclature, IP phones interconnect with webs or networks.

Phone sets capable of making an IP phone call have appeared in the marketplace, and owing to its low phone rate, the IP phone users grow day by day. Therefore, it is a trend to add IP phone function to a phone system; however, the extra cost makes the price of a phone system increase obviously. If a company intends to make all phone sets have IP phone function, the company has to buy IP phone sets to replace the original ones and has to extra construct IP phone lines; thus, large sums of money will be expended.

Accordingly, the present invention proposes an IP phone server for a KSUless telephone system to effectively overcome the abovementioned problem.

### SUMMARY OF THE INVENTION

The primary objective of the present invention is to provide an IP phone server for a KSUless telephone system, which can provide IP phone function for a basic phone system neither with an exchange nor with IP phone circuits inside phone sets. Thus, the equipment cost can be reduced.

Another objective of the present invention is to provide an IP phone server for a KSUless telephone system, wherein a time division multiplex system enables a basic phone set to make/receive an IP phone call, which is a function originally possessed by a high-level phone set.

Further objective of the present invention is to provide an IP phone server for a KSUless telephone system, wherein the time division multiplex system uses a phase shift keying technology to share data with other communication devices.

To achieve the abovementioned objectives, the present invention proposes an IP phone server for a KSUless telephone system, which comprises: a data intercom device, receiving the data of a primary phone line, and sending it out; a time division multiplex system, transforming the data input by the data intercom device into time division multiplex data whereby at least one another communication device can make/receive an IP phone call via the primary phone line; a processor, encoding/decoding input data; and at least one IP phone module, receiving the data processed by the processor, and sending it out via a network system. The present invention utilizes the time division multiplex system to provide the function of making/receiving IP phone calls for a general basic phone system; thereby, a general basic phone system can acquire IP phone function without extra cost.

To enable the objectives, technical contents, characteristics, and accomplishments of the present invention to be more easily understood, the embodiments of the present are to be described in detail below.

### BRIEF DESCRIPTION OF THE DRAWINGS

FIG. 1 is a diagram schematically showing the architecture of a high-level phone set having IP phone function and a time division multiplex system according to the present invention.

FIG. 2 is a diagram schematically showing the IP phone server according to the present invention applies to a KSUless telephone system.

### DETAILED DESCRIPTION OF THE INVENTION

The present invention is a IP phone server for a KSUless telephone system (KSU: Key Service Unit), which can provide IP phone function for an existing phone system, wherein each phone set is equipped with a time division multiplex system, i.e. TDOV (time division multiple access over voice line), and then, the existing phone system becomes a KSUless telephone system; further, among the phone system, one high-level phone set having IP phone function is set to be the IP phone server; and thereby, the other phone sets among the phone system can utilize the time division multiplex system to make/receive IP phone calls.

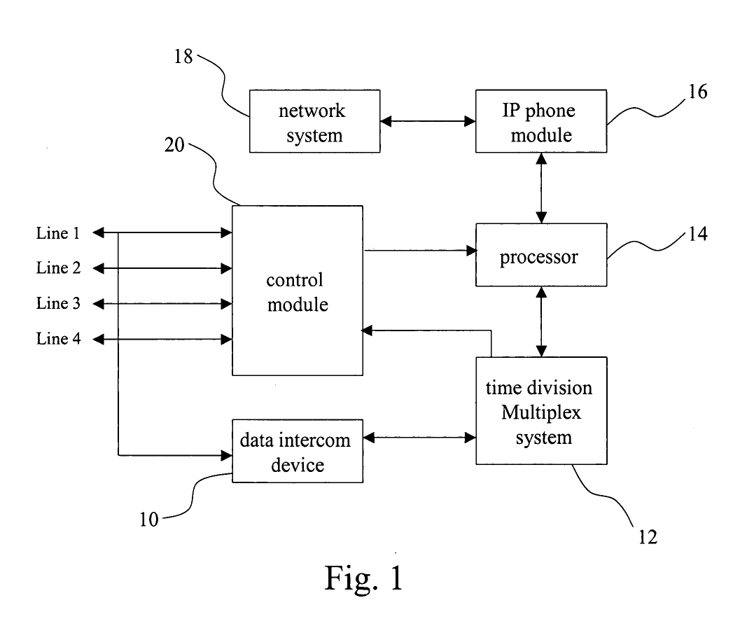

Refer to FIG. 1 for the architecture of the IP phone server according to the present invention. In the IP phone server according to the present invention, there are multiple phone lines, and herein, there are four phone lines, i.e. line 1, line 2, line 3, and line 4; line 1 is a primary phone line, which not only has general phone function but also can transmit TDOV data on the voice line, and lines 2, 3, 4 are general phone lines; a data intercom device 10 receives the data coming from the primary phone line—line 1 and then sends it to a time division multiplex system 12, and the data intercom device 10 also receives the data sent out by the time division multiplex system 12 and then transmits it to line 1; the time division multiplex system 12 utilizes the PSK (Phase Shift Keying) technology to transform the digitized data or digitized audio signals sent out by the data intercom device 10 into time division multiplex data; a processor 14 encodes/decodes input data, and at least one IP phone module 16 receives the signals from the processor 14 and sends it out via a network system 18; the IP phone module 16 has at least one IP phone number, and the network system 18 may be an Ethernet.

The architecture of the IP phone server according to the present invention also comprises a control module 20, which is used to operate general phone functions, such as call making/receiving, call holding, call transferring, etc. When one of lines 1 to 4 receives phone call signals, except IP phone calls, the phone call signals will be sent to the processor 14 directly via the control module 20.

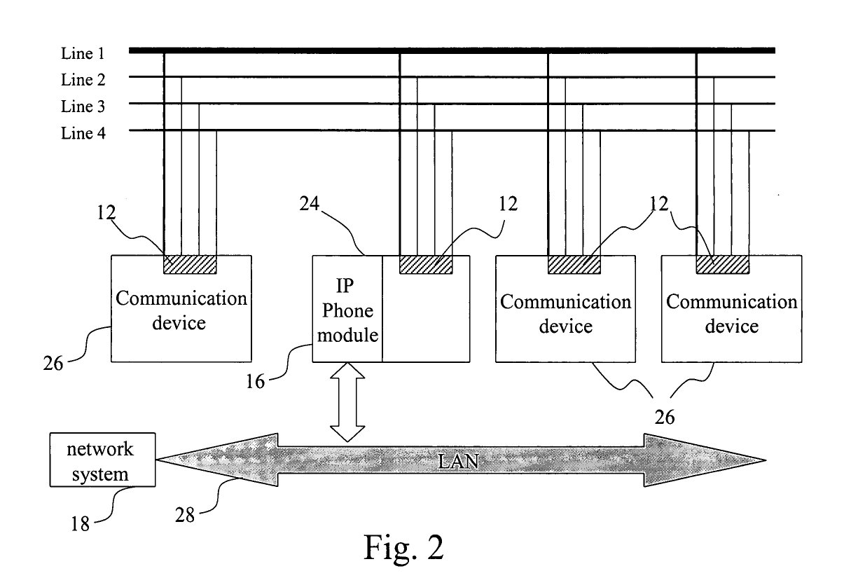

Refer to FIG. 2 for a diagram schematically showing the IP phone server according to the present invention applies to a KSUless telephone system. As shown in FIG. 2, the KSUless telephone system KSUless telephone system KSUless telephone system has four phone lines, but all the data of the time division multiplex system are transmitted only via line 1, and lines 2 to 4 are only general phone lines. Three communication devices 26 do not have the function of making/receiving IP phone calls and may be general basic phone sets. The communication device, which functions as a IP phone server 24, is a high-level phone set having the IP phone module 16 and IP phone function. The high-level IP phone server 24 and the low-level communication devices 26 respectively have their own time division multiplex systems 12.

The user can make a IP phone call directly via the IP phone server 24, wherein the IP phone module 16 will link a LAN 28 (Local Area Network) to send the signals out via the network system 18. Referring to both FIG. 1 and FIG. 2, when the user makes a IP phone call via the communication device 26, he will firstly make an internal call to utilize the time division multiplex system 12 of the communication device 26 to initiate the IP phone module 16 of the IP phone server 24 to dial the IP phone number; once the call is connected and answered, the IP phone signals will be transmitted by the IP phone module 16 to the time division multiplex system 12 for PSK processing and then sent by the data intercom device 10 to the communication device 26 via the internal_call function of line 1.

The user can receive a IP phone call directly via the IP phone server 24, wherein the IP phone module 16 receives the telecom signals input from the network system 18 via the LAN 28. The user can also receive a IP phone call via the communication device 26, wherein the user makes an internal call to line 1 in order to connect the built-in time division multiplex system 12 of the communication device 26 to the time division multiplex system 12 of the IP phone server 24, and then, the user can receive the IP phone call via the IP phone module 16.

If the received IP phone call is to be transferred, the telecom signals are firstly received by the IP phone module 16, and then encoded/decoded by the processor 14, PSK-processed by the time division multiplex system 12, sent to the data intercom device 10, and finally transmitted to one communication device 26 via the internal call function of line 1; thereby, all the phone sets can receive IP phone calls, and an incoming IP phone can be otherwise received by another phone set.

In summary, the present invention is a IP phone server for a KSUless telephone system, wherein the time division multiplex system 12 PSK-processes the digitized data or digitized audio signals, and then PSK-processed signals are transmitted to another phone set via the existing phone line; thereby, the objective of sharing resource can be achieved via multi-channel internal phone lines. Thus, the present invention can utilize only one high-level phone set having IP phone function to implement the other phone sets among the phone system to make/receive IP phone calls without installing an extra exchange or installing a IP phone circuit to each phone set of the phone system. Therefore, the cost of IP phone construction can be obviously reduced.

Those described above are not intended to limit the scope of the present invention but only to be the preferred embodiments of the present invention. Any equivalent modification or variation according to the characteristics or the spirit of the claims of the present invention is to be included within the scope of the present invention.

What is claimed is:

1. A IP phone server for a KSUless telephone system, comprising:
a data intercom device, receiving the data of a primary phone line, and sending it out;
a time division multiplex system, transforming the data sent out by said data intercom device into time division multiplex data whereby at least one another communication device can make/receive a IP phone call via said primary phone line;
a processor, encoding/decoding input data; and
at least one IP phone module, receiving the data processed by said processor, and sending it out via a network system.

2. The IP phone server for a KSUless telephone system KSUless telephone system KSUless telephone system according to claim 1, wherein said network system is an Ethernet.

3. The IP phone server for a KSUless telephone system KSUless telephone system KSUless telephone system according to claim 1, wherein said time division multiplex system and said IP phone module send data to said processor for encoding and decoding.

4. The IP phone server for a KSUless telephone system KSUless telephone system KSUless telephone system according to claim 1, wherein said communication device also has said time division multiplex system, which utilizes the phase shift keying technology to transmit data to said communication device via said primary phone line and implements the internal call function of said communication device.

5. The IP phone server for a KSUless telephone system KSUless telephone system KSUless telephone system according to claim 1, wherein said IP phone module comprises at least one IP phone number.

6. The IP phone server for a KSUless telephone system KSUless telephone system KSUless telephone system according to claim 1, further comprising a control module for controlling the functions of interoffice phone sets.
